(19) United States
(12) Patent Application Publication
(10) Pub. No.: US 2026/0170855 A1
(43) Pub. Date: Jun. 18, 2026

(54) MULTI-TEMPROAL 3-DIMENSIONAL OBJECT DETECTION

(71) Applicants: DENSO International America, Inc., Southfield, MI (US); Carnegie Mellon University, Pittsburgh, PA (US); DENSO CORPORATION, Kariya (JP)

(72) Inventors: Shawn HUNT, Bethel Park, PA (US); Navyata SANGHVI, Pittsburgh, PA (US); Kris KITANI, Pittsburgh, PA (US); Jinhyung PARK, Pittsburgh, PA (US); Hiroki ADACHI, Pittsburgh, PA (US)

(21) Appl. No.: 19/073,398

(22) Filed: Mar. 7, 2025

Related U.S. Application Data
(60) Provisional application No. 63/733,141, filed on Dec. 12, 2024.

(51) Int. Cl. G06V 20/64; G06V 10/25; G06V 10/62; G06V 10/774; G06V 10/82; G06V 20/40; G06V 20/56

(52) U.S. Cl. CPC G06V 20/64; G06V 10/25; G06V 10/62; G06V 10/774; G06V 10/82; G06V 20/41; G06V 20/56

(57) ABSTRACT

Described herein are embodiments for machine-learning by generating pseudo-labels for unlabeled training data using multiple temporal directions. Examples capturing a video of an environment surrounding a vehicle, the video comprising a sequence of image frames, detecting a first set of objects in the environment by applying the sequence of image frames to a 3-dimensional (3D) object detector in a first temporal direction, and detecting a second set of objects in the environment by applying the sequence of image frames to the 3D detector in a second temporal direction that differs from the first temporal direction. Examples also include generating a pseudo-label for the video based on the first and second set of objects and training the 3D object detector based on the generated pseudo-label.

### CROSS-REFERENCE TO RELATED APPLICATION

This application claims the benefit of U.S. Provisional Application No. 63/733,141 filed Dec. 12, 2024, the entire disclosure of which is incorporated by reference herein.

### TECHNICAL FIELD

The present disclosure relates, in general, to semi-supervised, 3-dimensional object detection using multi-temporal pseudo-labeling.

### BACKGROUND

Some machine learning (ML) algorithms build a mathematical model based on sample data, commonly referred to as training data, to make predictions or decisions without being explicitly programmed to do so. Essentially, the ML algorithm receives training data and based on the output of the ML algorithm, will have one or more weights of the ML algorithm adjusted.

One approach to training an ML algorithm includes supervised training. Supervised training involves the use of annotated training data, commonly referred to as labeled training data. Labeled training data is training data that includes the data to be processed, as well as an annotation (or label) specifying the correct prediction, classification, or decision that the ML algorithm being trained should reach based on processing the data. For example, if the ML algorithm is being trained to determine if an image is that of either a cat or a dog, the training data would include images of cats and dogs, as well as labels indicating if an image is actually of a cat or dog. During supervised training, the images would be provided to the ML algorithm and based on the output of the ML algorithm and the labels, the one or more weights of the ML algorithm will be adjusted. Over time, the output of the ML algorithm will be adjusted such that it can accurately classify, determine, or predict whether an image contains a dog or a cat.

One drawback of supervised training is that the training data must include labels. Labeling training data is generally performed manually, by a human operator. As such, in the example given above, the human operator must review each image, determine if the image is that of a cat or dog, and then label the image with the correct answer.

This difficulty in labeling data to generate sets of training data can be compounded in more complex applications, such as in the training of ML-based object detection algorithms being developed for the use in vehicles. Moreover, ML-based object detection algorithms may require a significant amount of training data to properly train the object detection algorithm to recognize a plethora of different objects that may surround a vehicle.

### SUMMARY

Described herein are embodiments for machine-learning by generating pseudo-labels for unlabeled training data using multiple temporal directions. In an embodiment, a method is provided for generating pseudo-labels for unlabeled training data using multiple temporal directions. The method includes capturing a video of an environment surrounding a vehicle, the video comprising a sequence of image frames, detecting a first set of objects in the environment by applying the sequence of image frames to a 3-dimensional (3D) object detector in a first temporal direction, and detecting a second set of objects in the environment by applying the sequence of image frames to the 3D detector in a second temporal direction that differs from the first temporal direction. The method also includes generating a pseudo-label for the video based on the first and second set of objects and training the 3D object detector based on the generated pseudo-label.

In an embodiment, a system is provided for generating pseudo-labels for unlabeled training data using multiple temporal directions. The system comprises a memory storing instructions and a processor communicatively connected to the memory. The processor is configured to execute the instructions to capture a video of an environment surrounding a vehicle, the video comprising a sequence of image frames, detect a first set of objects in the environment by applying the sequence of image frames to a 3-dimensional (3D) object detector in a first temporal direction, and detect a second set of objects in the environment by applying the sequence of image frames to the 3D detector in a second temporal direction that differs from the first temporal direction. The processor is further configured to generate a pseudo-label for the video based on the first and second set of objects and train the 3D object detector based on the generated pseudo-label.

In another embodiment, a non-transitory computer-readable medium for semi-supervised object detection is provided. The non-transitory computer-readable medium includes instructions that, when executed by one or more processors, cause the one or more processors to capture a video of an environment surrounding a vehicle, the video comprising a sequence of image frames, detect a first set of objects in the environment by applying the sequence of image frames to a 3-dimensional (3D) object detector in a first temporal direction, and detect a second set of objects in the environment by applying the sequence of image frames to the 3D detector in a second temporal direction that differs from the first temporal direction. The instructions further cause the one or more processors to generate a pseudo-label for the video based on the first and second set of objects and train the 3D object detector based on the generated pseudo-label.

### BRIEF DESCRIPTION OF THE DRAWINGS

The drawings described herein are for illustrative purposes only of select embodiments and not all possible implementations, and are not intended to limit the scope of the present disclosure.

FIG. 1 illustrates a vehicle incorporating a unsupervised pseudo-label generation system, according to examples of the present disclosure;

FIG. 2 illustrates an example unsupervised pseudo-label generation system, in accordance with examples of the present disclosure;

FIG. 3 illustrates a process flow for generating pseudo-labels, in accordance with an example of the present disclosure;

FIG. 4 illustrates a method for generating pseudo-labels, in accordance with an example of the present disclosure; and

FIG. 5 illustrates a method for semi-supervised training for 3D object detection, in accordance with an example of the present disclosure.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative bases for teaching one skilled in the art to variously employ the embodiments. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical application. Various combinations and modifications of the features consistent with the teachings of this disclosure, however, could be desired for particular applications or implementations.

Described herein is a system and method for ML learning through generating pseudo-labels for unlabeled training data using multiple temporal directions. As stated in the background section, supervised training of an ML algorithm requires the use of training data paired with label data. The label data contains the information that the ML algorithm is being trained to accurately predict. However, the labeling of the training data can be a time-consuming and tedious process, greatly limiting the amount of training data available for training an ML algorithm.

Examples of the present disclosure generate pseudo-labels for training data that can be utilized to train an ML algorithm in an unsupervised manner. The generated pseudo-labels can be based on object detection of unlabeled training data in multiple temporal directions. Examples herein predict intermediate labels from unlabeled training data through object detection in multiple temporal directions and ensembles the predictions from the multiple temporal directions to generate pseudo-labels. The unlabeled data can be annotated with the pseudo-labels and used for training of the ML algorithm. Moreover, the examples herein can leverage a self-supervised reconstruction loss to train directly from the unlabeled training data by masking the unlabeled training data and annotating the masked unlabeled training data with predictions from temporal priors.

In various examples, the unlabeled training data may be one or more videos in the form of sequences of image frames containing objects for training a three-dimensional (3D) object detection algorithm, which, once trained, results in 3D object detection model. The sequence of image frames may be captured by one or more camera sensors, for example, one or more monocular cameras, one or more visible light cameras that capture images of an environment within its field-of-view (FOV) including color information (e.g., an red-green-blue (RGB) camera or the like), one or more IR cameras, or the like, as well as combinations thereof. In some examples, the resulting 3D object detection model may be deployed in autonomous systems that utilize object detection to detect and classify objects surrounding in an environment for making operation decisions (e.g., autonomous vehicle systems for autonomous and/or semi-autonomous vehicle operation).

The camera system may capture the sequence of images frames in a first temporal direction (e.g., forwards in time) having a time step between consecutive image frames corresponding to a frame rate of the camera system. Each image frame may include a number of objects in the environment for a respective time step. The sequence of image frames can be applied to the 3D object detection algorithm in the first temporal direction to detect a first set of objects, transform the first set of objects to a first set of object queries, and predict a first-temporally dependent intermediate label for the image frames. “Object queries” refers to sets of learnable numerical representations (e.g., embeddings) of objects contained in the unlabeled training data that the ML algorithm is being trained to predict. In the context of object detection, a label (such as a first-temporally dependent intermediate label) may be provided as a set of bounding boxes that identify predicted locations of the objects that the ML algorithm is being trained to predict, along with a set of object identifiers that identifies a predicted type of each object (also referred to as a class). The 3D object detection algorithm may also detect a second set of objects by processing the sequence of image frames in a second temporal direction that differs from the first temporal direction (e.g., backwards in time). The 3D object detection algorithm may also transform the second set of objects to a second set of object queries and predict one or more second-temporally dependent intermediate labels. The second set of objects may be the same objects as or different objects than the first set of objects. Ideally, the second set of objects includes the same objects as the first set of objects. However, it may be that the detected objects differ between the first and second set of objects due to the difference in temporal directions and observing certain objects for a longer period of time, as described herein. The first- and second-temporally dependent intermediate labels may be examples of predictions, in this case, temporally dependent predictions.

Examples herein can merge the first and second set of objects by generating one or more pseudo-labels the image frames through ensembling (e.g., merging via one or more matching algorithms) the first- and second-temporally intermediate labels. Similar to the above, the pseudo-labels may be provided as a set of bounding boxes that identify predicted locations of the third set of objects and a set of object identifiers that identifies a predicted type of each object (also referred to as a class). By so doing, the unlabeled training data can be annotated with the pseudo-labels, without the time-consuming and tedious process of manual annotations.

In an example implementation, the 3D object detection algorithm can be trained in two stages to provide the 3D object detection model. During a first stage, the 3D object detection algorithm can be trained on an amount of labeled training data until convergence to remove randomness. Convergence can be reached when the accuracy of the 3D object detection algorithm reaches a first threshold accuracy, which can be verified using labeled verification data (e.g., an even smaller set of labeled data used to verify the predictions or classifications of the 3D object detection algorithm). The first stage may be considered a supervised training stage. During a second stage, unlabeled data can be labeled using the examples disclosed herein to annotate unlabeled training data with pseudo-labels. The 3D object detection algorithm can be trained on both the labeled training data and unlabeled training data annotated with pseudo-labels, which may be referred to as pseudo-labeled training data. In some implementations, the labeled and unlabeled training data may be evenly sampled (e.g., equal number of labeled and unlabeled training data during each batch and/or epoch). The second stage may be referred to as a semi-supervised training stage.

The second stage can be divided into sub-stages. During a first sub-stage, pseudo-labels can be generated from multiple temporal directions, as described herein. The first sub-stage may be referred to as a multi-temporal semi-supervised training stage. In a second sub-stage, training can be focused on deployment settings, during which the pseudo-labels may be generated using a subset of temporal directions representative of deployment conditions. For example, the second sub-stage may generate pseudo-labels using the forward in time temporal direction, which may be representative of a real-world deployment (e.g., the temporal direction in which the camera sensor captures videos during real-world applications). The second-sub-stage may be referred to as a deployment semi-supervised training stage.

Recently, camera-driven 3D object detection has seen improvements, achieving performance on par with that of LiDAR-based 3D detection. Improvements in 2D backbones, advancements in 3D object detection, and emphasis on temporal modeling of objects have fueled camera-driven 3D object detection, making camera-centric pipelines an integral component for autonomous driving systems due to cost efficiency and semantically accurate predictions. However, deployment of camera-driven 3D object detection through supervised learning can be hindered by the labor-intensive annotating of data samples. Accordingly, the examples disclosed herein can provide for a scalable deployment on by leveraging the unsupervised pseudo-labeling.

Some conventional approaches have explored semi-supervised learning for 2D and 3D object detection. During operation, camera systems, such as those used for autonomous vehicle systems and advanced safety systems, capture videos as collections of image frames in a temporal sequence. 3D object detection generally utilizes depth estimation, which can be a bottleneck for camera-based 3D object detectors. The temporal aspect of these videos can offer valuable priors about the surrounding environment that can improve the 3D object detections.

Yet, the temporal aspect of camera-driven 3D object detection remains under-explored. For instance, decoupled pseudo-labeling (DPL) proposes a semi-supervised learning (SSL) pipeline for 3D object detection, but is built on a single-image 3D detector that does not use video and thus lacks temporal considerations, which upper bounds the performance. Another approach provides for monocular 3D object detection through multi-view consistency. This approach leverages images from other time steps during training for photometric consistency loss, but is limited to single-image 3D detectors. Still other approaches use an additional LiDAR sensor to generate pseudo-labels, but LiDAR sensors can be expensive, which hinders scalability.

Moreover, the conventional approaches that attempt to leverage the above-discussed temporal aspects rely on a forward pass of the videos. However, pseudo-labels predicted for objects in front of a 3D object detector tend to be worse than those pseudo-labels for objects that are behind the 3D object detector. This can be because, as the detection moves forward in time and passes objects, the detector observes objects for a longer period of time and can refine the predictions for more precise localization as the object passes by the 3D object detector.

With this knowledge, examples disclosed herein leverage the multiple temporal directions predictions, which can be symmetric for refining and improving proved pseudo-labeling. For example, if a sequence of image frames is processed backwards in time, the examples herein can observe objects that are originally in front of the 3D detector (e.g., when viewed forwards in time) for a longer period of time, allowing for improved pseudo-labels of objects located in front.

Accordingly, examples herein provide an SSL framework that trains 3D object detectors from multiple temporal directions. Through the training disclosed herein, the present disclosure can provide performant, temporal 3D object detectors that exploit the temporal relations in videos for semi-supervised learning. The examples herein can, therefore, operate using cost-effective cameras systems, such as RGB cameras and the like, without a need for expensive supplemental systems (e.g., LiDAR sensors). However, while examples herein may operate without such supplemental systems, these examples may be integrated with the supplemental systems as desired.

In some implementations, the examples herein can incorporate the pseudo-labeling of unlabeled data with a self-supervised loss term directly on images frames. To generate pseudo-labels, the examples may focus on the problem of 3D localization. Pseudo-labeling errors can be significantly higher for regions behind the detector (e.g., an ego-vehicle in some examples) compared to regions ahead. To address this problem, the examples herein train a 3D object detection algorithm on multiple temporal directions of a sequence of image frames. For example, a 3D object detection algorithm can be trained using forward-running sequences of image frames and on reversed backward-running sequences. Without additional training costs, the 3D object detection algorithm, conditioned on consecutive timestamps, can be configured for multiple temporal directions.

Examples herein may also incorporate a tracking mechanism to fill in missing object queries for tracked objects during the pseudo-labeling process. Tracking and pseudo-labeling can be dependent on an image quality of objects between consecutive image frames (e.g., an object detected and a predicted object query in one image frame may not be detected in a subsequent image frame due to image quality or other obstructions). Observing that camera-driven 3D detection is fundamentally a 2D detection task with 3D localization and attribute prediction, examples herein leverage a 2D object detector for detecting objects in the image frames and predicting 2D object queries. The 2D object detections and corresponding object queries can be used address inconsistencies in the camera-driven 3D detection. For example, the 3D object detection algorithm can include a 2D object detection module that provides for an auxiliary 2D detection task for each image frame. These 2D object detections (e.g., 2D predictions) can be output from the 2D object detection module and matched to 3D predictions from the 3D object detection algorithm to force consistency therebetween.

Furthermore, the examples herein may be configured to learn directly from the unlabeled training data (e.g., without pseudo-labels). For example, the 3D object detection algorithm can perform masked reconstruction on the image frames. However, directly adding a masked autoencoder (MAE) head may worsen performance due to conflicts between the 3D detection and the reconstruction. Accordingly, examples herein mask tokens on the 3D detection object queries themselves. For example, the 3D object queries may be encoded with information about the scene in the image frame and objects from the particular time step, as well as information about the scene and the objects from previous time steps, which facilitates the reconstruction task. To provide for reconstruction, the 3D object queries can be reconstructed from scene elements for both a current time step and past time steps, which is complementary to the temporal 3D object detection task.

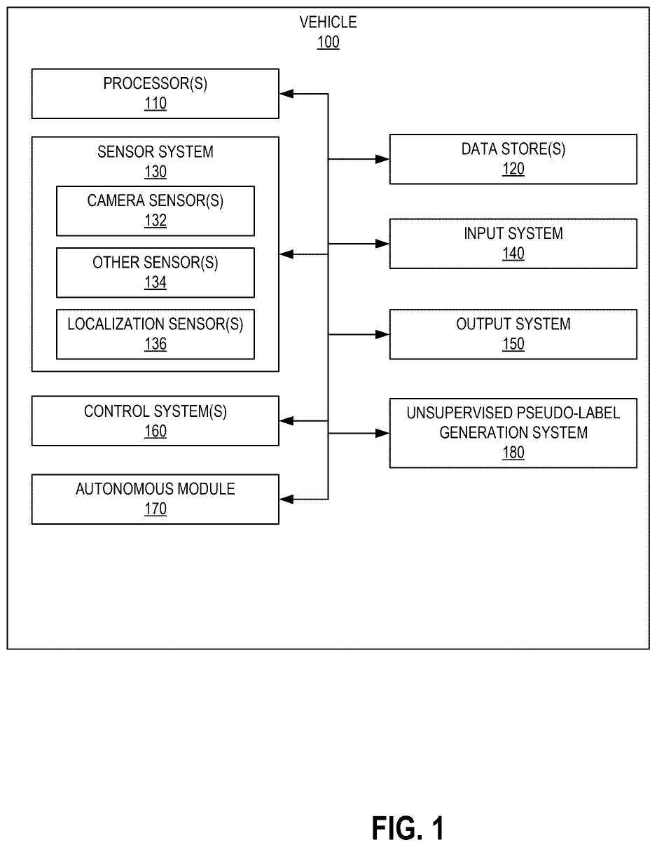

FIG. 1 illustrates a vehicle incorporating unsupervised pseudo-label generation. As used herein, a “vehicle” is any form of powered transport. In one or more implementations, the vehicle 100 is an automobile. While examples herein will be described herein with respect to automobiles, it will be understood that embodiments are not limited to automobiles. In some implementations, the vehicle 100 may be any robotic device or form of powered transport that, for example, includes one or more automated or autonomous systems, and thus benefits from the functionality discussed herein. In other examples, instead of a vehicle 100 or another robotic device, the system may simply be an object detection system that is able to receive information, such as image frames from a camera sensor, and determine the presence of one or more objects in the information.

In various examples, the automated/autonomous systems or combination of systems may vary. For example, in one aspect, the automated system can be a system that provides autonomous control of the vehicle according to one or more levels of automation, such as the levels defined by the Society of Automotive Engineers (SAE) (e.g., levels 0-5). As such, the autonomous system may provide semi-autonomous control or fully autonomous control, as discussed in relation to the autonomous module(s) 170.

The vehicle 100 also includes various elements. It will be understood that in various embodiments it may not be necessary for the vehicle 100 to have all of the elements shown in FIG. 1. The vehicle 100 can have any combination of the various elements shown in FIG. 1. Further, the vehicle 100 can have additional elements to those shown in FIG. 1. In some implementations, the vehicle 100 may be implemented without one or more of the elements shown in FIG. 1. While the various elements are shown as being located within the vehicle 100 in FIG. 1, it will be understood that one or more of these elements can be located external to the vehicle 100. Further, the elements shown may be physically separated by large distances and provided as remote services (e.g., cloud-computing services).

In various examples, the vehicle 100 may be an autonomous vehicle, but could also be a non-autonomous vehicle or a semi-autonomous vehicle. As used herein, “autonomous vehicle” refers to a vehicle that operates in an autonomous mode. “Autonomous mode” may refer to navigating and/or maneuvering the vehicle 100 along a travel route using one or more computing systems to control the vehicle 100 with minimal or no input from a human driver. In one or more embodiments, the vehicle 100 is highly automated or completely automated. In some examples, the vehicle 100 can be configured with one or more semi-autonomous operational modes in which one or more computing systems perform a portion of the navigation and/or maneuvering of the vehicle 100 along a travel route, and a vehicle operator (e.g., driver) provides inputs to the vehicle to perform a portion of the navigation and/or maneuvering of the vehicle 100 along a travel route. Such semi-autonomous operation can include supervisory control as implemented using the 3D object detection module 170 to ensure the vehicle 100 remains within defined state constraints.

The vehicle 100 can include one or more processors 110. In general, the processor(s) 110 may be electronic processor(s), such as one or more microprocessors capable of performing various functions as described herein. In some examples, the processor(s) 110 can be a main processor of the vehicle 100. For instance, the processor(s) 110 can be an electronic control unit (ECU). The vehicle 100 can include a sensor system 130. The sensor system 130 can include one or more sensors. The term “sensor” may refer any device, component, and/or system that can detect, and/or sense something. The one or more sensors can be configured to detect, and/or sense conditions of the vehicle and/or conditions in an environment surrounding the vehicle in real-time. As used herein, the term “real-time” means a level of processing responsiveness that a user or system senses as sufficiently immediate for a particular process or determination to be made, or that enables the processor to keep up with some external process.

In arrangements in which the sensor system 130 includes a plurality of sensors, the sensors can work independently from each other. In another arrangement, two or more of the sensors can work in combination with each other. In such a case, the two or more sensors can form a sensor network. The sensor system 130 and/or the one or more sensors can be operatively connected to the processor(s) 110 and/or another element of the vehicle 100 (including any of the elements shown in FIG. 1). The sensor system 130 can acquire data of at least a portion of the external environment of the vehicle 100.

The sensor system 130 can include any suitable type of sensor. Various examples of different types of sensors will be described herein. The sensor system 130 can include one or more environment sensors configured to acquire, and/or sense environment data surrounding the vehicle 100. “Environment data” includes data or information about the external environment in which vehicle 100 is located or one or more portions thereof. In the case where vehicle 100 is an automobile, environment data may be referred to as “driving environment data.” For example, the one or more environment sensors can be configured to detect, quantify and/or sense obstacles in at least a portion of the external environment of the vehicle 100 and/or information/data about such obstacles. Such obstacles may be stationary objects and/or dynamic objects, such as but not limited to, nearby vehicles in the vicinity surrounding vehicle 100, pedestrians, etc. The one or more environment sensors can be configured to detect, measure, quantify and/or sense other things in the external environment of the vehicle 100, such as, for example, lane markers, signs, traffic lights, traffic signs, lane lines, crosswalks, curbs proximate the vehicle 100, off-road objects, etc.

Various examples of environment sensors of the sensor system 130 will be described herein. However, it will be understood that the examples disclosed herein are not limited to the particular sensors described. As an example, in one or more arrangements, the sensor system 130 includes one or more camera sensors 132 disposed at one or more locations on an external body of vehicle 100. In examples, the one or more camera sensors 132 can be visible light cameras (e.g., cameras that captures images of an environment within its FOV including color information, such as RGB cameras and the like), high dynamic range (HDR) cameras or infrared (IR) cameras, monocular cameras, etc. In particular examples, the camera sensors 132 comprise RGB cameras. The one or more camera sensors 132 can be configured to capture videos of a driving environment, for example, sequences of image frames of the environment in which vehicle 100 is traveling. Each image frame may be separated by a time step corresponding to frame rate of the one or more camera sensors 132 (e.g., 30 Hertz, 60 Hertz, etc.). In some examples, the sensor system 130 may also include other environment sensors 134, such as but not limited to, one or more LIDAR sensors, one or more radar sensors, one or more sonar sensors, etc.

The sensor system 130 may also include one or more localization sensors 136. The localization sensors(s) 136 can be configured to detect and/or sense position and orientation changes of the vehicle 100, such as, for example, based on inertial acceleration. In one or more examples, the localization sensor(s) 136 can include one or more accelerometers, one or more gyroscopes, an inertial measurement unit (IMU), a dead-reckoning system, a global navigation satellite system (GNSS), a global positioning system (GPS), a navigation system, and/or other suitable sensors.

The vehicle 100 can include an input system 140. An “input system” includes any device, component, system, element, or arrangement or groups thereof that enable information/data to be entered into a machine. The input system 140 can receive an input from a vehicle occupant (e.g., a driver or a passenger). The vehicle 100 can include an output system 150. An “output system” includes any device, component, or arrangement or groups thereof that enable information/data to be presented to a vehicle occupant (e.g., a person, a vehicle passenger, etc.).

In some examples, the vehicle 100 can include one or more control system(s) 160. The vehicle 100 can include a steering control for controlling the steering of the vehicle 100, a throttle control for controlling the throttle of the vehicle 100, a braking control for controlling the braking of the vehicle 100, and/or a transmission control for controlling the transmission and/or other powertrain components of the vehicle 100. Each of these systems can include one or more devices, components, and/or a combination thereof, now known or later developed.

The vehicle 100 can include one or more modules, at least some of which are described herein. The modules can be implemented as computer-readable program code that, when executed by a processor(s) 110, implement one or more of the various processes described herein. One or more of the modules can be a component of the processor(s) 110, or one or more of the modules can be executed on and/or distributed among other processing systems to which the processor(s) 110 is operatively connected. The modules can include instructions (e.g., program logic) executable by one or more processor(s) 110.

In examples, one or more of the modules described herein can include artificial or computational intelligence elements, e.g., neural network, fuzzy logic, or other ML algorithms. Further, one or more of the modules can be distributed among a plurality of the modules described herein. In one or more arrangements, two or more of the modules described herein can be combined into a single module.

The vehicle 100 can include one or more autonomous module(s) 170 (also referred to as autonomous driving module(s) 170 in the case of automobile applications). The autonomous module(s) 170 can be configured to receive data from the sensor system 130 and/or any other type of system capable of capturing information relating to the vehicle 100 and/or the external environment of the vehicle 100. In one or more arrangements, the autonomous module(s) 170 can use such data to generate one or more driving scene models. The autonomous module(s) 170 can determine the position and velocity of the vehicle 100. The autonomous module(s) 170 can determine the location of obstacles or other environmental features, including but not limited to, traffic signs, trees, shrubs, other vehicles in the vicinity surrounding vehicle 100, pedestrians, etc.

The autonomous module(s) 170 can be configured to receive, and/or determine location information for obstacles within the external environment of the vehicle 100 for use by the processor(s) 110, and/or one or more of the modules described herein to estimate position and orientation of the vehicle 100, vehicle position in global coordinates based on signals from a plurality of satellites, or any other data and/or signals that could be used to determine the current state of the vehicle 100 or determine the position of the vehicle 100 with respect to its environment for use in either creating a map or determining the position of the vehicle 100 in respect to map data.

The autonomous module(s) 170 can be configured to determine travel path(s), current autonomous maneuvers for the vehicle 100, future autonomous maneuvers and/or modifications to current autonomous maneuvers based on data acquired by the sensor system 130, driving scene models, and/or data from any other suitable source. “Driving maneuver” means one or more actions that affect the movement of a vehicle. Examples of driving maneuvers include accelerating, decelerating, braking, turning, moving in a lateral direction of the vehicle 100, changing travel lanes, merging into a travel lane, and/or reversing, just to name a few possibilities. The autonomous module(s) 170 can be configured to implement determined driving maneuvers. The autonomous module(s) 170 can cause, directly or indirectly, such autonomous driving maneuvers to be implemented. As used herein, “cause” or “causing” means to make, command, instruct, and/or enable an event or action to occur or at least be in a state where such event or action may occur, either in a direct or indirect manner. The autonomous module(s) 170 can be configured to execute various vehicle functions and/or to transmit data to, receive data from, interact with, and/or control the vehicle 100 or one or more systems thereof (e.g., one or more of vehicle control system(s) 130).

The vehicle 100 can include one or more data stores 120 for storing one or more types of data. The data store 120 can include volatile and/or non-volatile memory. Examples of suitable data stores 120 include RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The data store 120 can be a component of the processor(s) 110, or the data store 120 can be operatively connected to the processor(s) 110 for use thereby. The term “operatively connected,” as used throughout this description, can include direct or indirect connections, including connections without direct physical contact. The data store(s) 120 may be operatively conned to the sensor system 130, to the processor(s) 110, and/or another element of the vehicle 100 (including any of the elements shown in FIG. 1).

The one or more data stores 120 can store sensor data. In this context, “sensor data” may refer to any information from the sensor system 130 of the vehicle 100 is equipped with, including the capabilities and other information about such sensors.

The vehicle 100 also includes an unsupervised pseudo-label generation system 180. As will be explained below, the unsupervised pseudo-label generation system 180 may be configured to generate pseudo-labels for unlabeled training data by processing the unlabeled training data in multiple temporal directions. For example, unsupervised label generation system 180 may receive a sequence of image frames from camera sensors 130 as unlabeled training data. The unsupervised pseudo-label generation system 180 can use a 3D object detection algorithm to derive a first set of object queries by processing the image frames in a first temporal direction (e.g., the forward temporal direction) and predict, from the first set of object queries, a first-temporally dependent intermediate label for the sequence of image frames. A second-temporally dependent intermediate label can be predicted by processing the image frames in a second temporal direction (e.g., backward temporal direction). The unsupervised pseudo-label generation system 180 may ensemble the predictions to generate pseudo-labels, which the unsupervised pseudo-label generation system 190 may use to annotate the unlabeled training data. The sequence of image frames and annotations can be stored to the data stores 120 and used for training the 3D object detection algorithm.

Moreover, unsupervised pseudo-label generation system 180 may have the ability to incorporate a tracking mechanism to fill in missing detections. For example, unsupervised pseudo-label generation system 180 can leverage 2D object detections to predict 2D labels for each image frame of the sequence of image frames. The 2D predictions can be used to address inconsistencies in the predictions by the 3D object detection algorithm, for example, by matching the 2D labels to the 3D predictions and forcing consistency therebetween using a suitable matching algorithm. For example, the 2D object detection may predict, for each image frame, 2D labels, which the unsupervised pseudo-label generation system 180 can use to match with the pseudo-labels using, for example, a Hungarian matching algorithm or other suitable algorithm.

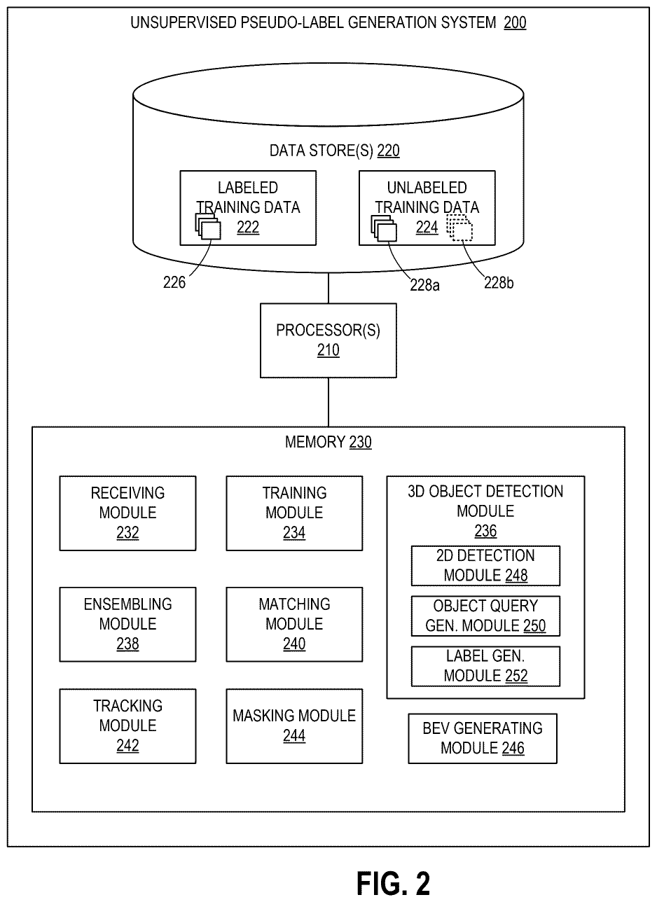

FIG. 2 illustrates an example unsupervised pseudo-label generation system, in accordance with examples of the present disclosure. The unsupervised pseudo-label generation system 200 may be an example of unsupervised pseudo-label generation system 180 of FIG. 1 or may be standalone system in some applications.

As shown in FIG. 2, the unsupervised pseudo-label generation system 200 may include one or more processor(s) 210. The processor(s) 210 may be a part of the unsupervised pseudo-label generation system 200 or the unsupervised pseudo-label generation system 200 may access the processor(s) 210 through a data bus or another communication path. In one or more examples, the processor(s) 210 can be an application-specific integrated circuit configured to implement functions associated with unsupervised pseudo-label generation system 200. In general, the processor(s) 210 may be an electronic processor such as a microprocessor that is capable of performing various functions as described herein. In some implementations, the processor(s) 210 may be implemented as processor(s) 110 of FIG. 1.

The unsupervised pseudo-label generation system 200 may also include one or more data store(s) 220, which may be operatively coupled to the processor(s) 210. The data store(s) 220 is, in some examples, an electronic data structure such as a database that can be stored in the memory 230 or another memory and that is configured with routines that can be executed by the processor(s) 210 for analyzing stored data, providing stored data, organizing stored data, and so on. Thus, in examples, the data store(s) 220 stores data used or generated by executing various functions of the unsupervised pseudo-label generation system 200. The data store(s) 220 may be an example of data store(s) 120 of FIG. 1.

In some examples, the data store(s) 220 may store labeled training data 222 that may be in the form of one or more labeled videos 226. The labeled video(s) 226 may be one or more videos paired with corresponding labels. A video may be a sequence of image frames separated by time steps that collectively define the temporal length of the video. Videos may generally be captured by camera sensors, such as camera sensors 132, which captures temporal sequences of image frames (e.g., pixels and image data) that depict scene of an environment, including one or more objects contained therein. The videos may be stored to data store(s) 220 through a data bus or another communication path or the camera sensors may be a part of the unsupervised pseudo-label generation system 200 (e.g., as shown in FIG. 1).

As noted above, a given video, as a sequence of image frames, may be paired with a label annotating the image frames. In some examples, the annotations may be used in supervised training, as well as in deployment applications. A label may indicate portions of each image frame (e.g., collections of pixels and corresponding image data) representing objects in each image frame of the sequence. The label may include a bounding box for each object, as well as other information, such as an object identifier indicative of a type (or class) of each object. The type (or class) of an object may be, for example but not limited to, a car, a truck, a bus, a trailer, a construction vehicle, a pedestrian, a bicycle, a motorcycle, traffic, a barrier, etc. The labeled training data 220 may act as a ground truth during supervised training of one or more ML algorithms. As explained previously, the labeled training data 222 may be manually annotated, which can be a time-consuming and tedious process.

The data store(s) 220 may also include unlabeled training data 224. The unlabeled training data 224 may be similar to the labeled training data 222, except that the videos are not paired with manually annotated labels. Said another way, for example, unlabeled training data 224 may be in the form of one or more unlabeled videos 228a. Through executing various functions of unsupervised pseudo-label generation system 200, as will be detailed below, pseudo-labels 228b can be generated and the unlabeled videos 228a can be annotated with the pseudo-labels (e.g., resulting in pseudo-labeled training data) in an unsupervised manner that processes multiple temporal directions of the unlabeled videos 228a.

As will be explained herein, pseudo-labels 228b may be provided in the form of 3D bounding boxes and object identifiers predicted, by the unsupervised pseudo-label generation system 200, from the unlabeled videos 228a based on multiple temporal directions of the unlabeled videos 228a. Each pseudo-label 228b may comprise a set of bounding boxes and other information, which can be paired with an unlabeled video 228a from which the pseudo-label 228b was predicted to create pseudo-labeled training data. The pseudo-labeled training data can be utilized for training the one or more ML algorithms of the 3D object detection module 280. By doing so, 3D object detection module 280 may be trained in an unsupervised manner through unsupervised generation of pseudo-labels 228b from unlabeled training data 224.

While certain information is described herein as included in pseudo-labels, as well as manually annotated labels, the information may vary from application to application. In the above example, pseudo-labels include sets of bounding boxes and object identifiers for objects depicted in the image frames of a video. However, more information, less information, or other kinds of information may be included within a given label. Similarly, the labeled videos 222 may include more information, less information, or other kinds of information.

In the example of FIG. 2, the unsupervised pseudo-label generation system 200 includes a memory 230 operatively coupled to the processor(s) 210. The memory 230 may be configured to store various modules that, when executed by the processor(s) 210, cause the processor(s) 210 to perform the various functions disclosed herein. As such, a module may refer to, for example, computer-readable instructions that can be executed by the processor(s) 210. The memory 230 may be configured to store, for example, a receiving module 232, a training module 234, a 3D object detection module 236, an ensembling module 238, a matching module 240, a tracking module 242, a masking module 244, and a bird's eye view (BEV) generating module 246. The 3D objection detection module 236 may include a 2D detection module 248 (also referred to as a 2D detection head), an object query generation module 250, and a label generation module 252. The memory 230 may be a random-access memory (RAM), read-only memory (ROM), a hard disk drive, a flash memory, or other suitable memory for storing the modules 232-246.

With regard to the receiving module 232, the receiving module 232 may include instructions that, when executed by the processor(s) 210, cause the processor(s) 210 to receive data from one or more sources. For example, the receiving module 232 may be cause the processor(s) 210 to receive labeled training data 226 from the data store(s) 222. As stated before, the labeled training data 226 may be in the form of videos annotated with a label, for example, the video may include image frames comprising one or more objects annotated with bounding boxes and other information. Likewise, the receiving module 232 may cause the processor(s) 210 to receive unlabeled training data 226 from the data store(s) 222. In another example, the receiving module 232 may cause the processor(s) 210 to receive labeled training data 226 and/or unlabeled data from a camera system (e.g., camera system 130 of FIG. 1).

The 3D object detection module 236 may include instructions that, when executed by the processor(s) 210, cause the processor(s) 210 to predict labels for videos. For example, the 3D object detection module 236 may comprises one or more ML algorithms (collectively referred to herein as the 3D object detection algorithm) trained to or can be trained to predict a label as a set of 3D bounding boxes and object identifiers of objects contained in a video. The 3D object detection module 236 can annotate the video with the 3D bounding boxes and object identifiers. As noted above, a 3D bounding box identifies a predicted location in a 3D coordinate system of an object and the object identifier identifies a predicted type (or class) of the object. In examples, certain classes may be expected within an environment, for example, based on training, which the 3D object detection uses to classify detected objects into one of the classes. In examples in which the unsupervised pseudo-label generation system 200 is part of a vehicle (e.g., vehicle 100), object identifiers may include, but are not limited to, cars, trucks, buses, trailers, construction vehicles, pedestrians, bicycles, motorcycles, traffic, and barriers, to name a few illustrative examples. 3D object detection module 236 can be implemented for various tasks for autonomous operation, for example, by autonomous module 170 of FIG. 1, such as but not limited to, image annotation, activity recognition, trajectory planning, advanced safety warning, object tracking, and the like.

In an illustrative example, to make a prediction for camera-drive 3D object detection, the 3D object detection module 236 may receive, via receiving module 232, an input x as an image frame (e.g., RGB image frame) for single time step I∈ [symbol] ^{K×H×W×3}, where K is the number of camera sensors (e.g., camera sensor 132), the camera intrinsics, and the extrinsics et from localization sensors (e.g., localization sensors 136, such as IMU and/or GPU sensors) for a set of images [symbol] . The 3D object detection module 236 predicts a label y from the input x as a set of bounding boxes b∈ [symbol] ^{M×9+c}, where set of labels [symbol] are predicted such that each box has a predicted 3D location (e.g., x, y, z positions in a coordinate system and orientation), predicted dimensions (e.g., width, length, and height), predicted BEV velocity (e.g., velocities in the x, y, and z directions), and a class label (e.g., object identifier) between 1 and C. That is, for example, the 3D object detection module 236 predicts a set of bounding boxes b for a given input x, which can be refined, as will be described below, by considering predictions from temporal priors.

In examples, the 3D object detection module 236 may comprise one or more ML algorithms trained (or trainable) for 3D object detection from sequences of image frames. In particular examples, the 3D object detection module 236 may be trained for 3D object detection from a sequence of image frames captured, for example, by the one or more camera sensors 132. For example, the 3D object detection module 236 may be trained to classify objects contained in the image frames to certain classes and predict bounding boxes for each detected object. As an illustrative example, the 3D object detection module 236 may receive a sequence of image frames of an environment and predict a label for the image frames.

In the example of FIG. 2, the 3D object detection module 236 includes a 2D detection module 248, which may include instructions that, when executed by the processor(s) 210, cause the processor(s) 210 to detect objects in an image frame and extract sets of features therefrom. In an example, the 2D detection module 248 may comprise one or more ML algorithms trained to detect objects in image frames and extract sets of features (e.g. one or more features) of each object. “Features” as used herein is a set of information extracted from the image frames that identify an object, such as, information indicative of whether a certain region of the image contains certain properties attributable to the object depicted therein. Features may be, for example, points/corners, edges, regions of interest, ridges, or other structures represented in the image data of each image frame.

In various implementations, the ML algorithm(s) of the 2D detection module 248 may vary but includes at least object detection algorithms, such as convolutional neural networks (CNNs) or similar algorithms that can separate and classify aspects of the surrounding environment. In a particular example, the 2D detection module 248 may include a CNN backbone trained to extract sets of features from the image frames, which can be used to identify the objects depicted in the image frames. In other approaches, the ML algorithm(s) may include semantic segmentation algorithms, depth completion algorithms, clustering algorithms, and so on.

The 3D object detection module 236 includes an object query generation module 250, which may include instructions that, when executed by the processor(s) 210, cause the processor(s) 210 to generate object queries from sets of features identifying objects contained in the sequence of image frames. In an example, the object query generation module 250 may comprise one or more ML algorithms trained to derive object queries by processing the features extracted from the image frames, where object queries are learnable numerical representations (e.g., embeddings) of each object.

In various implementations, the ML algorithm(s) of the object query generation module 250 may vary but includes at least object generation algorithms, such as detection transforms (DETR) or similar algorithms that can process features to yield object queries. In a particular example, the object query generation 250 may include a DETR head configured yield the 3D object queries based on processing the features extracted by the 2D object detection module 248. In temporal implementations, the DETR may be configured to process features extracted by the 2D object detection module 248 for a first image frame of a first time step, 3D object queries derived from a second image frame of another time step (e.g., forward or backward time step depending on the application), and motion attributes between the time steps, such as ego-movement, predict object velocity, time difference between image frames, and the like.

The 3D object detection module 236 includes the label generation module 252, which may include instructions that, when executed by the processor(s) 210, cause the processor(s) 210 to predict a label for the sequence of image frames from 3D object queries generated by the object query generation module 250. In an example, the label generation module 252 may comprise one or more ML algorithms trained to compute bounding box parameters from the 3D object queries. In an illustrative example, the ML algorithm(s) may include a multilayer perceptron (MLP) or similar feedforward neural network that can process object queries to predict bounding box parameters defining a set of bounding boxes for the objects contained in the image frames. Bounding box parameters may include, but are not limited to, a 3D location, dimensions in 3D space, orientation such as rotational parameters, and predicted object velocity in the BEV coordinate system. The 2D detection module 248 may predict a type (or class) of each object, which the label generation module 252 can add to the set bounding boxes, resulting in a predicted label.

In examples, the label generation module 252 may yield a number of candidate bounding boxes (and object identifiers) for a given object. In this case, the label generation module 252 may compute a confidence score for each candidate bounding box (and object identifier) as a probability that the candidate bounding box actually represents the object. In examples, label generation module 252 may select the bounding box (and object identifier) having the highest confidence score as the bounding box (and object identifier) for the object.

In an illustrative implementation, the 3D object detection module 236 may be implemented as StreamPETR, as known in the art. StreamPETR comprises a CNN backbone and custom DETR head configured to predict bounding boxes for objects contained in a sequence of image frames.

The BEV generating module 246 may include instructions that, when executed by the processor(s) 210, cause the processor(s) 210 to convert the image frames to a BEV of the environment. In this case, the 3D object detection module 236 may perform a 2D object detection on each image frame to detect objects therein. The 3D object detection module 236 may then transform detected objects to 3D object queries, which can be propagated through the sequence of image frames, aggregating the object queries from one image frame with those of other image frames. Bounding boxes and types of objects of each object can then be predicted from 3D object queries. The predictions can be annotated on the BEV constructed by the BEV generating module 246.

The training module 234 may include instructions that, when executed by the processor(s) 210, cause the processor(s) 210 to train the one or more ML algorithms of the 3D object detection module 236, which once trained provide a 3D object detection model that can be stored to data store(s) 222 and deployed in real-world environments. For example, the training module 234 may be configured to train the ML algorithm(s) in a supervised and/or unsupervised manner. In some cases, training module 234 may be configured for supervised training, in which the ML algorithm(s) is trained to make distinctions between labeled training data 226 and unlabeled training data 224. This training can allow the algorithm to recognize patterns and ultimately operate autonomously without using labels. In other cases, the training module 234 may be configured for unsupervised training, in which the ML algorithm(s) is trained on unlabeled training data to generate and/or assign pseudo-labels to the unlabeled training data. The unlabeled training data paired with pseudo-labels can be used as pseudo-labeled training data for training the ML algorithm(s). In yet another case, the training module 234 may be configured for semi-supervised learning, in which the ML algorithm(s) is initially trained on labeled training data (e.g., a supervised stage) until a first convergence that removes randomness from the ML algorithm(s) and then trained on unlabeled training data (e.g., an unsupervised stage). In some examples, the unsupervised stage may include training on both labeled and unlabeled training data, which may be referred to as semi-supervised training. In any case, the training data and label provided manually or generated during the training process may be stored in data store(s) 120.

In semi-supervised learning, according to some of the examples here, the 3D object detection algorithm may be trained using a first set of labeled training data and a second set of unlabeled training data. The first set of labeled training data may be represented as

$$\begin{matrix}{𝒟}_{1} = \\ {\{ ( {x}_{i}^{l} , {y}_{i}^{l} ) \}}_{i = 1}^{{N}_{l}}\end{matrix}$$

and the second set of unlabeled training data may be represented as

$$\begin{matrix}{𝒟}_{2} = \\ {\{ ( {x}_{i}^{u} , {y}_{i}^{u} ) \}}_{i = 1}^{{N}_{u}}\end{matrix} ,$$

where Nₗ represents the number of data samples in the first set and Nᵤ represents the number of data samples in the second set. In examples, Mi is less than Nᵤ (e.g., Nₗ<<Nᵤ). In an illustrative examples, a set of 28,130 videos may be provided as the training data and Ni may be between 4000 or fewer labeled videos (e.g., 4000, 2000, 800, 600, etc. image frames that are manually labeled) and the remaining videos are unlabeled.

Training the 3D object detection module 236 may begin by initializing the ML algorithm(s) with one or more random or predefined weights that can be adjusted during the training. When a label is predicted (sometimes referred to as a predicted label or prediction) and compared to a ground truth (e.g., manually annotated label and/or generated pseudo-label), the training module 234 may iteratively adjust the weights to minimize the difference between predictions and ground truth labels. In some examples, a loss function (e.g., a reconstruction loss as will be described below) may also be implemented to quantify the error between the predicted outputs and the true labels. The loss function may be minimized during training.

In some examples, an optimization function can be implemented to adjust the weights of the training module 234 iteratively. An illustrative process to adjust the weights is gradient descent, although various optimization functions may be implemented. In some examples, the gradient of the loss function may be calculated with respect to the weights. The weights may be updated in the opposite direction of the gradient to minimize the loss.

Once the 3D object detection module 236 is trained (e.g., training reaches a desired accuracy threshold), the trained algorithm(s) can be store in data store(s) 120 as a 3D object detection model. The trained model may be used for predictions on new unlabeled data samples received, for example, by sensors system 130.

In examples, as will be explained below in more detail, the unsupervised pseudo-label generation system 200 may be configured to generate pseudo-labels 228b for unlabeled training data 228a by processing the unlabeled training data 228a in multiple temporal directions. For example, unsupervised pseudo-label generation system 200 may execute receiving module 232 to receive a sequence of image frames as unlabeled training data 228a. The unsupervised pseudo-label generation system 200 can execute the 3D object detection module 236 to predict first 3D bounding boxes (e.g., bounding boxes b, include object identifiers) for objects contained in the sequence of image frames from a first set of 3D object queries derived by processing the image frames in a first temporal direction (e.g., the forward temporal direction). The 3D bounding boxes and object identifiers predicted from the first temporal direction may be referred to as a first-temporally dependent intermediate label. A second intermediate label may be predicted by processing the image frames in a second-temporally dependent temporal direction (e.g., backward temporal direction) comprising second 3D bounding boxes. The first- and second-temporally dependent intermediate labels may be merged to generate pseudo-labels 228b, which the unsupervised pseudo-label generation system 200 may use to annotate the unlabeled training data 228a. The resulting annotated unlabeled data may be used for training of the 3D object detection module 236 by treating the pseudo-labels 228b as ground truths.

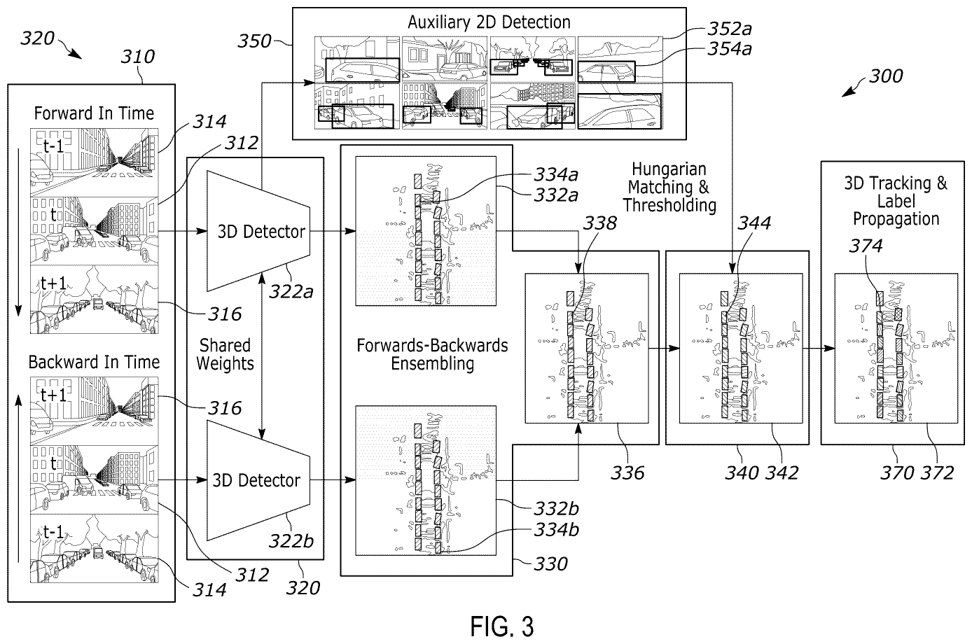

The functions of the modules 236-244 will now be described with reference to FIG. 3. FIG. 3 illustrates a process flow 300 for generating pseudo-labels in accordance with an example of the present disclosure. While process 300 is discussed in combination with the unsupervised pseudo-label generation system 200, it should be appreciated that the process 300 is not limited to being implemented within the unsupervised pseudo-label generation system 200 but is instead one example of a system that may implement the method 300.

At input phase 310, the receiving module 232 may receive a video as a sequence of image frames, each corresponding to a time step tᵢ. The receiving module 232 may input the sequence of image frames into the 3D object detection module 236, which processes the image frames in multiple temporal directions at prediction phase 320.

For example, as shown in FIG. 3, a first instance 322a of the 3D object detection module 236 processes the image frames in the forward temporal direction. More particularly, the first instances of the 3D object detection module 236 receives, via receiving module 232, an input x as an image frame Iₜ (shown in FIG. 3 as image frame 312) for single time step qₜ, with an aim to predict a first-temporally dependent intermediate label y as a set of 3D bounding boxes b, as described above, for each object detected in image frame 312. To this end, the first instance 322a of the 3D object detection module 236 detects a set of objects in the image frame 312 and extract sets of features. For example, the 3D object detection module 236 may execute the 2D detection module 248 (e.g., a CNN or similar algorithm) to extract features fₜ by applying input image frame Iₜ to the 2D detection algorithm. In the case of a CNN, 2D detection module 248 may extract features fₜ=CNN (Iₜ).

The first instance 322a of the 3D object detection module 236 may execute object query generation module 250 to generate 3D object queries from the features fₜ based on object queries from a prior time step qₜ₋₁. For example, object query generation module 250 may execute one or more ML algorithms (e.g., DETR or similar algorithms) trained to derive 3D object queries by processing the features fₜ, 3D object queries derived from a prior image frame Iₜ₋₁ (shown in FIG. 3 as image frame 314) of a prior time step qₜ₋₁, and motion attributes between the current time step and prior time step (e.g., ego-movement, predicted 3D location, predicted dimensions, predict BEV velocity, time difference between image frames, and the like). These 3D object queries may be referred to as forward-temporal 3D object queries.

Using the forward-temporal 3D object queries, the first instance 322a of 3D object detection module 236 may execute label generation module 252 to predict bounding box parameters for each object contained in the input image frame Iₜ. For example, label generation module 252 may execute one or more ML algorithms (e.g., a MLP or similar algorithm) trained to compute bounding box parameters from 3D object queries. In the case of an MLP, label generation module 252 may predict bounding box parameters ŷₜ=MLP (yₜ), where ŷₜ represents a first-temporally dependent intermediate label for image frame Iₜ comprising a set of bounding boxes b.

FIG. 3 depicts the set of 3D bounding boxes (one of which is labeled as bounding box 334a for illustrative purpose) of the first-temporally dependent intermediate label overlaid on a BEV 332a of the environment converted by the BEV generating module 246 from the sequence of image frames. In the example of FIG. 3, BEV 332a includes a greyed out portion, which illustrates the forward focus of the first instance 322a of 3D object detection module 236. In this case, the 3D object detection module 236 (e.g., an ego vehicle in which the 3D object detection module 236 can be installed) may be located in the center of BEV 332a. In some examples, the first instance 322a of 3D object detection module 236 may be configured to ignore (e.g., not process) the area behind the 3D object detection module 236, so to focus on the forward temporal direction.

The process can be repeated for each image frame to compute a first-temporally dependent intermediate label by considering prior time steps. That is, for example, a first-temporally dependent intermediate label can be computed for time step qₜ₊₁ using the above described processing considering image frame Iₜ for time step qₜ as the prior time step.

In a similar manner, a second instance 322b of the 3D object detection module 236 processes the image frames to yield a second-temporally dependent intermediate label for image frame Iₜ by processing the sequence of image frames in the backward temporal direction. In this case, the 3D object detection module 236 may execute the 2D detection module 248 to extract features fₜ by applying input x as image frame Iₜ to the 2D detection algorithm, as described above. This step may be the same as that of the first instance 322a or may be separate iteration of the 2D detection module 248. In either case, instance 322b of the 3D object detection module 236 may execute object query generation module 250 to generate backward-temporal 3D object queries from the features fₜ based on object queries from a future time step qₜ₊₁, in a manner similar to that described above. Using the backward-temporal 3D object queries, the second instance 322b of 3D object detection module 236 may execute label generation module 252 to predict bounding box parameters for each object contained in the input image frame Iₜ. The resulting bounding box parameters may be referred to as a second-temporally dependent intermediate label for image frame Iₜ.

FIG. 3 depicts the set of 3D bounding boxes (one of which is labeled as bounding box 334b for illustrative purpose) of the second-temporally dependent intermediate label overlaid on a BEV 332b of the environment converted by the BEV generating module 246 from the sequence of image frames. In the example of FIG. 3, BEV 332b includes a greyed out portion, which illustrates the backward focus of the second instance 322b of 3D object detection module 236. In some examples, the second instance 322b of 3D object detection module 236 may be configured to ignore (e.g., not process) the area in front the 3D object detection module 236, so to focus on the backward temporal direction.

In the example of FIG. 3, the instances 322a and 322b are instances of the same 3D object detection module 236 (e.g., the same 3D object detection algorithm). As such, the instances share weights as shown in FIG. 3. However, in some implementations, the 3D object detection algorithms may be different, for example, instance 322a may be dedicated for forward temporal processing and instance 302b may be dedicated for backward temporal processing. In this case, the weights need not be shared between the instances as each instance may result in a separate model.

At ensembling phase 330, the unsupervised pseudo-label generation system 200 may execute assembling module 238, which may include instructions that, when executed by the processor(s) 210, cause the processor(s) 210 to ensemble the first- and second-temporally dependent intermediate labels to intermediate pseudo-labels. For example, the temporally dependent intermediate labels from the first and second temporal directions can be merged thereby ensembling the predictions and provide a resulting intermediate pseudo-label that accounts for multiple temporal directions (e.g., both forward and backward in time). In examples, ensembling the first- and second-temporally dependent intermediate labels may comprise executing a suitable matching algorithm so to match objects and temporally dependent intermediate labels predicted in the first temporal direction to those from the second temporal direction. In an illustrative example, a Hungarian matching algorithm may be utilized that computes loss between the two sets of objects and temporally dependent intermediate labels.

FIG. 3 depicts a set of 3D bounding boxes (one of which is labeled as bounding box 338 for illustrative purpose) of intermediate pseudo-labels overlaid on a BEV 336 of the environment converted by the BEV generating module 246 from the sequence of image frames.

In some examples, the intermediate pseud-labels may be sufficient (e.g., accurate enough) to function as pseudo-labels 228b and used by the unsupervised pseudo-label generation system 200 to annotate the unlabeled data 228a. In this case, the sequence of image frames and annotations can be stored to the data store(s) 220 and used by the training module 234 for training of the 3D object detection algorithm.

In some examples, a matching/thresholding phase 340 may be utilized. At the matching/thresholding phase 340, the unsupervised pseudo-label generation system 200 may execute matching module 240. Matching module 240 may include instructions that, when executed by the processor(s) 210, cause the processor(s) 210 to fill in object detection that may have been missed or inconsistently classified by the 3D object detection module 236. For example, matching module 240 can leverage an auxiliary 2D detection phase 350, where the 2D object detection module 248 predicts 2D labels (e.g., 2D bounding boxes and object identifiers) for each image frame of the sequence. In the example of FIG. 3, a number of image frames are illustrated each having 2D predictions overlaid thereon, for example, image frame 352 (as an illustrative example of the image frames of phase 350) includes a 2D prediction 354 depicted as a 2D bounding box. The 2D bounding box may be also include an object identifier (not shown in FIG. 3). The 2D predictions can be used by the matching module 240 to correct inconsistencies and/or missing objects in the 3D predictions (e.g., bounding box parameters). For example, matching module 240 may perform one or more matching algorithms to correlate the 2D predictions to the 3D predictions and force consistency therebetween. In an example, the 2D detection module 248 may predict, for each image frame, 2D bounding boxes and object identifiers, which the matching module 240 can use to match with the 3D predictions using, for example, a Hungarian matching algorithm or other suitable algorithm. The matched predictions may be referred to as matched intermediate pseudo-labels.

FIG. 3 depicts a BEV 342 of the environment converted by the BEV generating module 246 from the sequence of image frames, which includes a set of matched predictions (one of which is labeled as bounding box 344 for illustrative purpose) overlaid thereon.

While some conventional implementations of matching algorithms exist, these implementations utilize predictions from different models and different modalities (e.g., comparing RBG model predictions to LiDAR model predictions). The examples herein utilize 3D and 2D predictions from the same model (e.g., the 3D objection detection module) and same modality (e.g., camera sensors) to improve matching to force consistency. Accordingly, the matching module 240 may be configured to execute a matching algorithm (e.g., Hungarian matching algorithm or the like) between the 2D and 3D predictions by minimizing focal loss, generalize intersection over union (GIoU), and 2D box parameter difference. For example, each 3D prediction (e.g., 3D bounding box and object identifier) is paired with each 2D prediction (e.g., 2D bounding box and object identifier). For each pair, a matching score can be computed from the focal loss, GIoU, and 2D box parameter difference using the Hungarian matching algorithm (or other suitable matching algorithm). The pair with the smallest score (e.g., minimizes the focal loss, GIoU, and 2D box parameter difference) can be considered as representing the same object. By performing this across all 3D predictions, consistency with the 2D predictions can be ensured, such that all objects in the image frames are addressed. By thresholding on the matching cost, the matching module 240 may boost pseudo-label quality and retain low-confidence 3D detections that would otherwise have been discarded, with minimal or no additional cost to training or inference and negligible increase in runtime pseudo-labeling.

In some examples, at 3D tracking and label propagation phase 360, the unsupervised pseudo-label generation system 200 may execute tracking module 242. The tracking module 242 may include instructions that, when executed by the processor(s) 210, cause the processor(s) 210 to track and maintain objects across the sequence of image frames to ultimately predict the pseudo-label 228b for the sequence of image frames. The pseudo-label 228b resulting from the 3D tracking and label propagation phase 360 may be used to annotated unlabeled training data 224a for using training the 3D object detection algorithm.

FIG. 3 depicts a BEV 362 of the environment converted by the BEV generating module 246 from the sequence of image frames, which includes a set of matched predictions (one of which is labeled as bounding box 364 for illustrative purpose) overlaid thereon. The various BEVs 332a, 332b, 336, 342, and 362 may be substantially the same and in some cases may be examples of a single BEV generated by the BEV generating module 246.

While the 3D object detection module 236 may be able to maintain most objects through time, due to uncertainty, distance between the detector and the objects, or occlusions, object detections may disappear between image frames. Such missing detections can negatively influence the final trained model and can exacerbate the problem of object impermanence. To address this issue, tracking module 242 may be configured with a predicted velocity-based tracking pipeline, where the 3D object detection algorithm determines a tracklet for each object at each time step and each tracklet from a prior time step can be matched with a prediction for a current image frame moved to the other time step using predicted velocity.

Camera-based predictions may have per-image frame velocity errors. To alleviate this, tracking module 242 may be configured to maintain a velocity of each tracklet, which can be set as an exponential moving average (EMA) of a change over time of a center location of a prediction associated with the object in question. During tracking, tracking module 242 may move the tracklet forward halfway in time according to the velocity and move the prediction backward halfway in time according to the velocity. The movements may be done for each tracklet and each prediction. Thus, tracking module 242 locates moved tracklets that meet (e.g., intersect) with the moved predictions to identify matches, which can be used to maintain object predictions (e.g., bounding box parameters) over time.

Referring back to FIG. 2, in some examples, the unsupervised pseudo-label generation system 200 may be configured execute masking module 244 to enable training of the 2D detection module 248 on unlabeled training data. Masking module 244 may include instructions that, when executed by the processor(s) 210, cause the processor(s) 210 to formulate an object query conditioned masked reconstruction loss, which can enable the 3D detection module 236 to learn directly from unlabeled training data. For example, the masking module 244 conditions masked tokens on the object queries. The object queries not only encode information about the scene and objects from a given time step, but encode information from other time steps, which facilitates the reconstruction task. To solve the reconstruction task, masking module 244 may be configured to encourage the object queries to focus on scene elements for both current and past time steps, which can be complementary to the temporal 3D object detection task.

As an illustrative example, to formulate an object query-conditioned masked reconstruction loss, the masking module 244 masks input image frames and process them with the features extracted by the 2D detection module 248 (e.g., a CNN or similar algorithms):

$${f}_{t}^{mask} = CNN ( M ⊙ {I}_{t} ) \qquad Eq . 1$$

where

$${f}_{t}^{mask}$$

represents the masked natures for time step t; M is the masking function, which may be any suitable mask function; and Iₜ is an image frame for time step t.

$$The {f}_{t}^{mask}$$

encodes information about the visible part of the image frame Iₜ.

While conventional approaches directly input

$${f}_{t}^{mask}$$

into a masked decoder for pre-training, this can hurt the performance of the 3D object detection module 236. This may be because the network focuses on optimizing the auxiliary loss at the expense of the main task loss. To more explicitly tie the 3D object detector 236 to the reconstruction, the masking module 244 may update the masked features

$${f}_{t}^{mask}$$

by conditioning the masked features

$${f}_{t}^{mask}$$

using the object queries output object from the object query generation module 250 (e.g., the temporal DETR head or other suitable algorithms). For examples:

$${\tilde{f}}_{t}^{mask} = TransformerDecoder ( {f}_{t}^{mask} , {q}_{t} , {q}_{t} ) \qquad Eq . 2$$

where

$$TransformerDecoder ( {f}_{t}^{mask} , {q}_{t} , {q}_{t} )$$

performs self-attention between the masked features

$${f}_{t}^{mask}$$

and then performs cross-attention, pulling information from time step qₜ to refine

$${f}_{t}^{mask} .$$

Eq. 2 shows self-attention and cross-attention at a current time step qₜ.

By conditioning the masked reconstruction on the predicted object queries, the masking module 244 can enable gradient flow from the reconstruction loss to influence the temporal DETR head directly. To minimize the reconstruction loss, the object queries may retain information about scene elements from both current and past time steps, which can be complementary to the temporal 3D object detection task. As a result, the 2D objection detection module 248 (e.g., the CNN or similar algorithms) can be trained directly on unlabeled data.

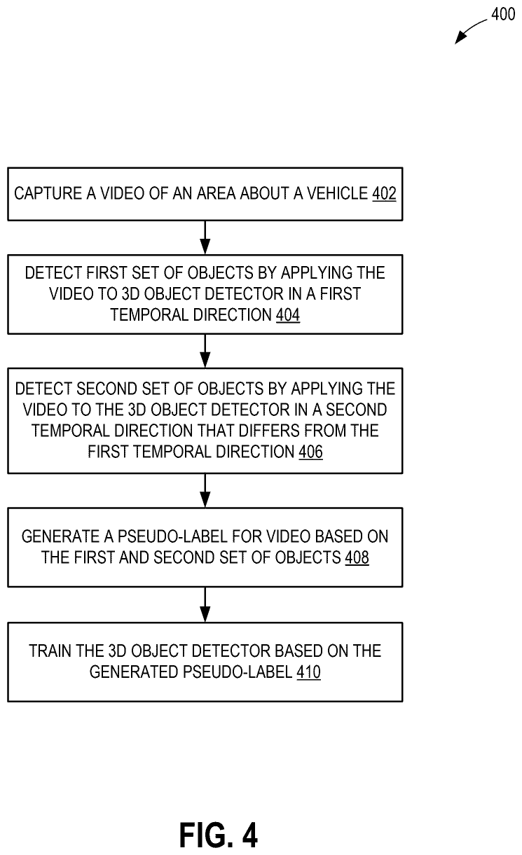

FIG. 4 illustrates an example method 400 for generating pseudo-labels, in accordance with an example of the present disclosure. The method 400 may be implemented, for example, as computer-readable instructions that can be executed by one or more processor(s). For example, method 400 may be executed by processor(s) 110 of FIG. 1 and/or processor(s) 210 of FIG. 2. As such, method 400 may be implemented by one or more of the components described in connection with FIG. 1 and/or FIG. 2.

At step 402, a video of an environment can be captured, for example, by a sensor system (e.g., sensor system 130 of FIG. 1). In particular examples, the video may be captured by a camera sensor, such as camera sensor(s) 132. As described above, the video includes a sequence of image frames of an environment surrounding the sensor system captured at a time step (e.g., each image frame is separated in time by a time step). In particular examples, the sensor system may be installed in a vehicle (e.g., vehicle 100) and configured to capture image frames of the driving environment.

At step 404, a first set of objects can be detected by applying the sequence of image frames to a 3D object detector in a first temporal direction. In examples, the first temporal direction may be a forward pass in time of the sequence of image frames. For example, as described above in connection with FIGS. 1-3, the 3D object detector may detect features for each object contained in the image frames can be extracted, by a neural network (e.g., a CNN or similar object detection algorithm) for each time step. 3D object queries (e.g., forward-temporal 3D object queries) can be derived from the features, for example, using a DETR. More particularly, 3D object queries can be derived by processing the features of an image frame of a current time step, 3D object queries determined for an image frame of a prior time step, and motion attributes between the current time step and prior time step. The 3D object queries can be generated iteratively for each image frame by considering 3D object queries for preceding time steps.

At step 406, a second set of objects can be detected by applying the sequence of image frames to the 3D object detector in a second temporal direction that differs from the first temporal direction. In examples, the second temporal direction may be a backward pass in time of the sequence of image frames. For example, as described above in connection with FIGS. 1-3, the 3D object detector may detect features for each object contained in the image frames can be extracted, by a neural network (e.g., a CNN or similar object detection algorithm) for each time step. 3D object queries (e.g., backward-temporal 3D object queries) can be derived from the features, for example, using the DETR. More particularly, 3D object queries can be derived by processing the features of an image frame of a current time step, 3D object queries determined for an image frame of a future time step, and motion attributes between the current time step and prior time step. The 3D object queries can be generated iteratively for each image frame by considering 3D object queries for future time steps.

In examples, the second set of objects may be the same as or may be different from the first set of objects detected at step 404. For example, by applying the applying the sequence of image frames to the 3D object detector in a second temporal direction, the 3D object detector may be detect objects that coincide with one or more objects of the first set of objects. Ideally, the second set of objects contains the same objects as the first set of objects. However, it may be that the objects detected at steps 404 and 406 differ due to the difference in temporal directions and observing certain objects for a longer period of time, as described above. The resulting differences may be addressed by tracking and maintaining objects through time, as well as forcing consistency through a matching algorithm, as described.

At step 408, a pseudo-label for the video based on the first and second set of objects. For example, as described above in connection with FIGS. 1-3, a first-temporally dependent intermediate label can be predicted for the video from the first set of objects and a second-temporally dependent intermediate label can be predicted for the video from the second set of objects. More particularly, the forward-temporal 3D object queries can be applied to a bounding box prediction algorithm (e.g., an MLP or similar algorithm) that predicts bounding box parameters defining a set of bounding boxes for the objects contained in the image frames from the forward-temporal 3D object queries. Likewise, the backward-temporal 3D object queries can be applied to a bounding box prediction algorithm (e.g., an MLP or similar algorithm) that predicts bounding box parameters defining a set of bounding boxes for the objects contained in the image frames from the backward-temporal 3D object queries. The resulting bounding boxes (e.g., first- and second-temporally dependent intermediate labels) can be merged to determine an intermediate pseudo-label. In some examples, this intermediate pseudo-label may be used for annotating the unlabeled training data.

In some examples, the pseudo-labels generated at step 408 may also be generated by matching the intermediate pseudo-labels with 2D predictions. For example, as described above in connection with FIGS. 1-3, step 408 may leverage auxiliary 2D detections for each image frame of the sequence. The 2D predictions can be used to correct inconsistencies in the 3D predictions (e.g., intermediate pseudo-label). For example, step 408 may include executing one or more matching algorithms (e.g., a Hungarian matching algorithm) to correlate the 2D predictions to the intermediate pseudo-label (e.g., the set of bounding boxes) and force consistency therebetween.

Step 408 may also include tracking and maintaining objects across the sequence of image frames to provide the pseudo-label for of the video for accurate annotating, as described in connection with FIG. 3 above. For example, step 408 may include matching a tracklet for a prior time step with an intermediate pseudo-label (or a matched intermediate pseudo-label) for a current image frame moved backward in time using predicted velocity.

Step 408 may also include formulating an object query conditioned masked reconstruction loss, as described above in connection with FIG. 3. For example, step 408 may include conditioning masked tokens on the 3D object queries and encouraging the 3D object queries to focus on objects for both a current time step and past time steps.

At step 410, the 3D object detector can be trained based on the generated pseudo-label. For example, as described above in connection with FIGS. 1-3, the video can be annotated with the pseudo-label generated at step 408 and the 3D object detector can be trained on the annotated video as pseudo-labeled training data.

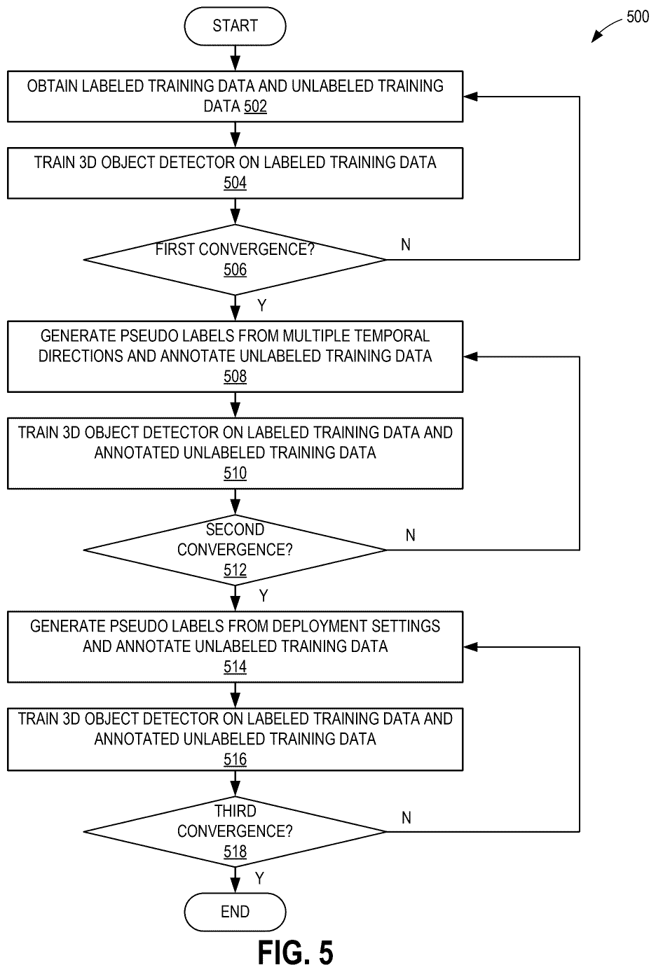

FIG. 5 illustrates an example method 500 for semi-supervised training for 3D object detection, in accordance with an example of the present disclosure. The method 500 may be implemented, for example, as computer-readable instructions that can be executed by one or more processor(s). For example, method 400 may be executed by processor(s) 110 of FIG. 1 and/or processor(s) 210 of FIG. 2. As such, method 400 may be implemented by one or more of the components described in connection with FIG. 1 and/or FIG. 2.

In an example implementation, the 3D object detection algorithm can be trained in two stages to provide a resulting 3D object detection model. At the start, the 3D object detection algorithm can be initialized with one or more random or predefined weights that can be adjusted during the training.

During the first stage, at step 502, a set of labeled training data and a second set of unlabeled training can be obtained. In examples, the size of the labeled training data (e.g., number of videos) is less than the size of unlabeled training data, and more particularly significantly less. At step 504, the 3D object detection algorithm can be trained on the labeled training data until first convergence to remove randomness. At step 506, a determination is made as to whether or not the first convergence has been reached. For example, the 3D object detection algorithm is evaluated if the accuracy of the 3D object detection algorithm reaches a first threshold accuracy using a first verification dataset (e.g., a set of labeled data that is smaller than the labeled training data and used to verify the predictions or classifications of the 3D object detection). If the accuracy reaches the first threshold accuracy, the method 500 proceeds to a second stage. The first threshold accuracy may be selected to remove randomness from the 3D object detection algorithm. Otherwise, the method 500 returns to step 502.

During the second stage, at step 508, unlabeled training data can be annotated by generating pseudo-labels according to the examples described in connection with FIGS. 1-4. The above description applies herein and is not repeated in connection with method 500 for brevity. The 3D object detection algorithm can be trained on both the labeled training data and unlabeled training data annotated with pseud-labels. In some implementations, the labeled and unlabeled data may be evenly sampled (e.g., equal number of labeled and unlabeled data during each batch and/or epoch).

The second stage can be divided into sub-stages. During a first sub-stage, the pseudo-labels can be generated from multiple temporal directions, as described herein (steps 508) and the 3D object detection algorithm can be trained on the labeled and unlabeled training data set (step 510). At step 512, a determination is made as to whether or not a second convergence has been reached. For example, the 3D object detection algorithm is evaluated to determine if the accuracy of the 3D object detection algorithm reaches a second threshold accuracy that is higher than the first threshold accuracy using a second verification data set. If the accuracy reaches the second threshold accuracy, the method 500 proceeds to the second-sub stage. Otherwise, the method 500 returns to step 508.

In the second sub-stage, at step 514, training can be focused on deployment settings, during which the pseudo-labels may be generated using a subset of temporal directions representative of deployment conditions. For example, step 514 may generate pseudo-labels using the forward pass temporal direction, which may be representative of a real-world deployment. At step 516, the 3D object detection algorithm can be trained on the labeled training data and the unlabeled training data annotated using deployment settings, until a third convergence is reached. At step 518, a determination is made as to whether or not the third convergence has been reached. For example, the 3D object detection algorithm is evaluated to determine if the accuracy of the 3D object detection algorithm reaches a third threshold accuracy that is higher than the second threshold accuracy using a third verification data set. If the accuracy reaches the third threshold accuracy, the method 500 ends and the trained 3D object detection algorithm can be stored as a 3D object detection model. Otherwise, the method 500 returns to step 514.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, to the extent any embodiments are described as less desirable than other embodiments or prior art implementations with respect to one or more characteristics, these embodiments are not outside the scope of the disclosure and can be desirable for particular applications.

The flowcharts and block diagrams in the figures illustrate the architecture, functionality, and operation of possible implementations of systems, methods, and computer program products according to various embodiments. In this regard, each block in the flowcharts or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved.

The systems, components and/or processes described above can be realized in hardware or a combination of hardware and software and can be realized in a centralized fashion in one processing system or in a distributed fashion where different elements are spread across several interconnected processing systems. Any kind of processing system or another apparatus adapted for carrying out the methods described herein is suited. A typical combination of hardware and software can be a processing system with computer-usable program code that, when being loaded and executed, controls the processing system such that it carries out the methods described herein. The systems, components and/or processes also can be embedded in a computer-readable storage, such as a computer program product or other data programs storage device, readable by a machine, tangibly embodying a program of instructions executable by the machine to perform methods and processes described herein. These elements also can be embedded in an application product which comprises all the features enabling the implementation of the methods described herein and, which when loaded in a processing system, is able to carry out these methods.

Furthermore, arrangements described herein may take the form of a computer program product embodied in one or more computer-readable media having computer-readable program code embodied, e.g., stored, thereon. Any combination of one or more computer-readable media may be utilized. The computer-readable medium may be a computer-readable signal medium or a computer-readable storage medium. The phrase “computer-readable storage medium” means a non-transitory storage medium. A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer-readable storage medium would include the following: a portable computer diskette, a hard disk drive (HDD), a solid-state drive (SSD), a read-only memory (ROM), an erasable programmable read-only memory (EPROM or Flash memory), a portable compact disc read-only memory (CD-ROM), a digital versatile disc (DVD), an optical storage device, a magnetic storage device, or any suitable combination of the foregoing. In the context of this document, a computer-readable storage medium may be any tangible medium that can contain or store a program for use by or in connection with an instruction execution system, apparatus, or device.

Generally, module, as used herein, includes routines, programs, objects, components, data structures, and so on that perform particular tasks or implement particular data types. In further aspects, a memory generally stores the noted modules. The memory associated with a module may be a buffer or cache embedded within a processor, a RAM, a ROM, a flash memory, or another suitable electronic storage medium. In still further aspects, a module as envisioned by the present disclosure is implemented as an application-specific integrated circuit (ASIC), a hardware component of a system on a chip (SoC), as a programmable logic array (PLA), or as another suitable hardware component that is embedded with a defined configuration set (e.g., instructions) for performing the disclosed functions.

Program code embodied on a computer-readable medium may be transmitted using any appropriate medium, including but not limited to wireless, wireline, optical fiber, cable, RF, etc., or any suitable combination of the foregoing. Computer program code for carrying out operations for aspects of the present arrangements may be written in any combination of one or more programming languages, including an object-oriented programming language such as Java™, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

“A”, “an”, and “the” as used herein refers to both singular and plural referents unless the context clearly dictates otherwise. By way of example, “a processor” programmed to perform various functions refers to one processor programmed to perform each and every function, or more than one processor collectively programmed to perform each of the various functions. The terms “including” and/or “having,” as used herein, are defined as comprising (i.e., open language). The phrase “at least one of . . . and . . . ” as used herein refers to and encompasses any and all possible combinations of one or more of the associated listed items. As an example, the phrase “at least one of A, B, and C” includes A only, B only, C only, or any combination thereof (e.g., AB, AC, BC, or ABC). Furthermore, the term “or”, as used herein, may be construed in either an inclusive or exclusive sense. Moreover, the description of resources, operations, or structures in the singular shall not be read to exclude the plural. Conditional language, such as, among others, “can,” “could,” “might,” or “may,” unless specifically stated otherwise, or otherwise understood within the context as used, is generally intended to convey that certain examples include, while other examples do not include, certain features, elements and/or steps.

Terms and phrases used in this document, and variations thereof, unless otherwise expressly stated, should be construed as open ended as opposed to limiting. Adjectives such as “conventional,” “traditional,” “normal,” “standard,” “known,” and terms of similar meaning should not be construed as limiting the item described to a given time period or to an item available as of a given time, but instead should be read to encompass conventional, traditional, normal, or standard technologies that may be available or known now or at any time in the future. The presence of broadening words and phrases such as “one or more,” “at least,” “but not limited to” or other like phrases in some instances shall not be read to mean that the narrower case is intended or required in instances where such broadening phrases may be absent.

Aspects herein can be embodied in other forms without departing from the spirit or essential attributes thereof. Accordingly, reference should be made to the following claims, rather than to the foregoing specification, as indicating the scope hereof.

What is claimed is:

1. A method of generating pseudo-labels for unlabeled training data using multiple temporal directions, the method comprising:
capturing a video of an environment surrounding a vehicle, the video comprising a sequence of image frames;
detecting a first set of objects in the environment by applying the sequence of image frames to a 3-dimensional (3D) object detector in a first temporal direction;
detecting a second set of objects in the environment by applying the sequence of image frames to the 3D detector in a second temporal direction that differs from the first temporal direction;
generating a pseudo-label for the video based on the first and second set of objects; and
training the 3D object detector based on the generated pseudo-label.

2. The method of claim 1, wherein the first temporal direction is a forward pass in time of the sequence of images and the second temporal direction is a backward pass in time of the sequence of images.

3. The method of claim 1, wherein the video comprises a time step between the image frames of the sequence of image frames, wherein detecting the first set of objects comprises extracting, by a neural network, features from one or more image frames at each time step in a forward temporal direction, wherein detecting the second set of objects comprises extracting, by the neural network, features from one or more image frames at each time step in a backward temporal direction.

4. The method of claim 3, further comprising:
generating a first set of object queries for the first set of objects by iteratively processing features extracted from one or more image at a respective time step, object queries of a previous time step preceding the respective time step, and motion attributes between the previous time step and the respective time step.

5. The method of claim 3, further comprising:
predicting, using a multi-layer perceptron (MLP), bounding box parameters for the first set of objects from the first set of object queries.

6. The method of claim 3, further comprising:
generating a second set of object queries for the second set of objects by iteratively processing features extracted from one or more image at a respective time step, object queries of a next time step following the respective time step, and motion attributes between the respective time step and the next time step.

7. The method of claim 3, further comprising:
predicting, using a multi-layer perceptron (MLP), bounding box parameters for the second set of objects from the second set of object queries.

8. The method of claim 1, further comprising:
predicting a first-temporally dependent intermediate label for the video from the first set of objects;
predicting a second-temporally dependent intermediate label for the video from the second set of objects; and
deriving an intermediate pseudo-label for the video by ensembling the first-temporally dependent intermediate label and second-temporally dependent intermediate label.

9. The method of claim 8, further comprising:
predicting two-dimensional (2D) labels for the sequence of image frames based on applying the sequence of image frames to a 2D detector; and
matching the 2D labels with the intermediate pseudo-label by computing matching costs between the intermediate pseudo-label and the 2D labels,
wherein the pseudo-label for the video is based on thresholding the matching cost.

10. The method of claim 1, further comprising:
annotating the video with the generated pseudo-label; and
training the 3D object detector on the annotated video.

11. The method of claim 1, further comprising:
training the 3D object detector on a labeled dataset until convergence;
annotating an unlabeled dataset comprising the video, wherein the video is annotated with the generated pseudo-labels, wherein the unlabeled dataset is larger than the labeled dataset;
after convergence, training the 3D object detector on the annotated unlabeled dataset; and
training the 3D object detector based on deployment settings.

12. A system for generating pseudo-labels for unlabeled training data using multiple temporal directions, the system comprising:
a memory storing instructions; and
a processor communicatively connected to the memory and configured to execute the instructions to:
capture a video of an environment surrounding a vehicle, the video comprising a sequence of image frames;
detect a first set of objects in the environment by applying the sequence of image frames to a 3-dimensional (3D) object detector in a first temporal direction;
detect a second set of objects in the environment by applying the sequence of image frames to the 3D detector in a second temporal direction that differs from the first temporal direction;
generate a pseudo-label for the video based on the first and second set of objects; and
train the 3D object detector based on the generated pseudo-label.

13. The system of claim 12, wherein the video comprises a time step between the image frames of the sequence of image frames, wherein detecting the first set of objects comprises extracting, by a neural network, features from one or more image frames at each time step in a forward temporal direction, wherein detecting the second set of objects comprises extracting, by the neural network, features from one or more image frames at each time step in a backward temporal direction.

14. The system of claim 12, wherein the processor is further configured to execute the instructions to:
predict a first-temporally dependent intermediate label for the video from the first set of objects;
predict a second-temporally dependent intermediate label for the video from the second set of objects; and
derive an intermediate pseudo-label for the video by ensembling the first-temporally dependent intermediate label and second-temporally dependent intermediate label.

15. The system of claim 14, wherein the processor is further configured to execute the instructions to:
predict two-dimensional (2D) labels for the sequence of image frames based on applying the sequence of image frames to a 2D detector; and
match the 2D labels with the intermediate pseudo-label by computing matching costs between the intermediate pseudo-label and the 2D labels,
wherein the pseudo-label for the video is based on thresholding the matching cost.

16. The system of claim 12, wherein the processor is further configured to execute the instructions to:
annotate the video with the generated pseudo-label; and
train the 3D object detector on the annotated video.

17. The system of claim 12, wherein the processor is further configured to execute the instructions to:
training the 3D object detector on a labeled dataset until convergence;
annotating an unlabeled dataset comprising the video, wherein the video is annotated with the generated pseudo-labels, wherein the unlabeled dataset is larger than the labeled dataset;
after convergence, training the 3D object detector on the annotated unlabeled dataset; and
training the 3D object detector based on deployment settings.

18. A non-transitory computer-readable medium for semi-supervised object detection, the non-transitory computer-readable medium including instructions that, when executed by one or more processors, cause the one or more processors to:
capture a video of an environment surrounding a vehicle, the video comprising a sequence of image frames;
detect a first set of objects in the environment by applying the sequence of image frames to a 3-dimensional (3D) object detector in a first temporal direction;
detect a second set of objects in the environment by applying the sequence of image frames to the 3D detector in a second temporal direction that differs from the first temporal direction;
generate a pseudo-label for the video based on the first and second set of objects; and
train the 3D object detector based on the generated pseudo-label.

19. The non-transitory computer-readable medium of claim 18, wherein the first temporal direction is a forward pass in time of the sequence of images and the second temporal direction is a backward pass in time of the sequence of images.

20. The non-transitory computer-readable medium of claim 18, wherein the instructions further cause the one or more processors to:
predict a first-temporally dependent intermediate label for the video from the first set of objects;
predict a second-temporally dependent intermediate label for the video from the second set of objects; and
derive an intermediate pseudo-label for the video by ensembling the first-temporally dependent intermediate label and second-temporally dependent intermediate label.
